(19) United States
(12) Patent Application Publication
(10) Pub. No.: US 2015/0349440 A1
(43) Pub. Date: Dec. 3, 2015

(54) SEMICONDUCTOR MODULE SOCKET AND CONNECTION STRUCTURE OF THE SAME

(71) Applicant: SAMSUNG ELECTRONICS CO., LTD., Suwon-si (KR)

(72) Inventors: Jong-hyun SEOK, Seoul (KR); Dong-min JANG, Hwaseong-si (KR)

(21) Appl. No.: 14/666,492

(22) Filed: Mar. 24, 2015

(30) Foreign Application Priority Data
May 27, 2014 (KR) 10-2014-0063823

(51) Int. Cl. H01R 12/70; H01R 12/72

(52) U.S. Cl. CPC H01R 12/7076; H01R 12/721

(57) ABSTRACT

A semiconductor module socket includes an internal body including a slot therein, a lower end portion of a semiconductor module being inserted in the slot, and the semiconductor module including a printed circuit board with a semiconductor device thereon, an external body coupled to an outside of the internal body, and a plurality of socket pins on opposite surfaces of the slot, the plurality of socket pins facing each other, and top portions of the plurality of socket pins being arranged at different levels.

### CROSS-REFERENCE TO RELATED APPLICATION

Korean Patent Application No. 10-2014-0063823, filed on May 27, 2014, in the Korean Intellectual Property Office, and entitled: “Semiconductor Module Socket and Connection Structure of the Same,” is incorporated by reference herein in its entirety.

### BACKGROUND

1. Field

Embodiments relate to a semiconductor module on which a semiconductor device is mounted, and a semiconductor module socket to which a semiconductor module is coupled.

2. Description of the Related Art

Recently, an effort to increase speed and degree of integration of a main memory to improve the performance of a system including a central processing unit (CPU) is being made. In order to increase a data input/output speed of the main memory, a bus structure, through which packets are transmitted or received at a high speed, is employed between the CPU and the main memory. Also, a memory module, including a plurality of memory chips mounted on a printed circuit board (PCB), is used to increase the memory capacity of the main memory.

### SUMMARY

Embodiments provide a semiconductor module socket that may prevent scratches, damages, or short-circuits of the semiconductor module that are generated due to an insertion force applied when the semiconductor module is coupled to a socket for the semiconductor module, and a connection structure thereof.

According to an embodiment, a semiconductor module socket includes an internal body including a slot therein, a lower end portion of a semiconductor module being inserted in the slot, and the semiconductor module including a printed circuit board with a semiconductor device thereon, an external body coupled to an outside of the internal body, and a plurality of socket pins on opposite surfaces of the slot, the plurality of socket pins facing each other, and top portions of the plurality of socket pins being arranged at different levels.

Among the plurality of socket pins, the levels of the top portions of the plurality of socket pins formed at a center portion of the slot may be higher than the levels of the top portions of the plurality of socket pins formed at opposite end portions in a first direction of the slot.

Among the plurality of socket pins, the levels of the top portions of the plurality of socket pins formed at opposite end portions in a first direction of the slot may be higher than the levels of the top portions of the plurality of socket pins formed at a center portion of the slot.

The levels of the top portions of the plurality of socket pins may have heights of a first level and a second level that are different from each other, and, among the plurality of socket pins, a socket pin having the top portion of the first level and a socket pin having the top portion of the second level may be alternately arranged in a first direction of the slot.

Distances between the top portions and bottom portions of the plurality of socket pins may be identical to each other.

Levels of contact points where the plurality of socket pins and external contact terminals contact each other may be different from each other.

All bottom portions of the plurality of socket pins may be formed at the same level on the slot.

The plurality of socket pins may include a plurality of socket pin contact portions and a plurality of socket pin connection portions, and heights of the plurality of socket pin connection portions may be different from one another.

The semiconductor module socket may further include a lower groove that is coupled to a lower end portion of the printed circuit board, and a coupling portion that is formed at opposite end portions in a first direction of the external body.

According to another embodiment, a semiconductor module socket assembly structure includes a semiconductor module having a printed circuit board, at least one semiconductor device on the printed circuit board, and a plurality of external contact terminal on a lower end portion of opposite surfaces of the printed circuit board, and a semiconductor module socket accommodating the semiconductor module, the semiconductor module socket having an internal body including a slot therein, a lower end portion of the printed circuit board being inserted in the slot, an external body coupled to an outside of the internal body, and a plurality of socket pins on opposite surfaces of the slot and facing each other, the plurality of socket pins electrically contacting corresponding external contact terminals of the semiconductor module, and top portions of the plurality of socket pins being arranged at different levels.

Levels of contact points where the plurality of socket pins and the external contact terminals contact each other may be different from each other.

A distance between a pair of socket pins of the slot facing each other may be different from a distance between another pair of socket pins facing each other neighboring in a first direction of the slot.

The external contact terminals may be tabs for circuit connection.

A hook insertion groove may be formed in each of opposite end portions in a first direction of the printed circuit board of the semiconductor module, the semiconductor module socket may include a latch member, and the latch member may be coupled to the hook insertion groove.

The latch member may include a latch body pivotally coupled to the hook insertion groove, and an upper groove formed in the latch body and that couples to an upper end portion of opposite end portions in the first direction of the printed circuit board.

According to yet another embodiment, a semiconductor module socket for connecting a semiconductor module having at least one semiconductor device on a printed circuit board, the semiconductor module including an internal body including a slot, the slot exposing internal surfaces of the internal body, and a lower end portion of the semiconductor module being inserted in the slot, an external body on outer surfaces of the internal body, and a plurality of socket pins facing each other in the slot, the lower end portion of the semiconductor module in the slot contacting the plurality of socket pins, and contact points between the semiconductor module and the plurality of socket pins being at different height levels relative to a bottom of the slot.

Each of the plurality of socket pins may include a protrusion extending from the internal body into the slot, a distance between two facing protrusions of corresponding socket pins along a first direction being smaller than a width of the slot along the first direction.

The contact points between the semiconductor module and the plurality of socket pins may be contact points between the protrusions of the socket pins and corresponding external contact terminals on the semiconductor module.

The contact points between the semiconductor module and the plurality of socket pins may have varying height levels along a length direction of the slot.

The contact points between the semiconductor module and the plurality of socket pins may be at different height levels relative to the bottom of the slot.

### BRIEF DESCRIPTION OF THE DRAWINGS

Features will become apparent to those of skill in the art by describing in detail exemplary embodiments with reference to the attached drawings, in which:

FIG. 1 illustrates a perspective view of a semiconductor module according to an exemplary embodiment;

FIG. 2 illustrates a perspective view of a semiconductor module socket according to an exemplary embodiment;

FIG. 3 illustrates a perspective view for describing a process of the semiconductor module of FIG. 1 being coupled to the semiconductor module socket of FIG. 2;

FIGS. 4A and 4B illustrate cross-sectional views of the semiconductor module socket along line A-A′ of FIG. 3;

FIGS. 5 to 9 illustrate cross-sectional views of socket pins arranged in a slot of the semiconductor module socket along line B-B′ of FIG. 3;

FIG. 10 illustrates another cross-sectional view of the semiconductor module socket along line A-A′ of FIG. 3;

FIG. 11 illustrates a plan view of a semiconductor module socket according to an exemplary embodiment;

FIGS. 12A and 12B illustrate cross-sectional views of the semiconductor module socket along lines C-C′ and D-D′ of FIG. 11, respectively;

FIG. 13 illustrates a perspective view of a semiconductor module socket according to an exemplary embodiment; and

FIG. 14 illustrates a partially enlarged cross-sectional view of the semiconductor module being coupled to the semiconductor module socket illustrated in FIG. 13.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

Expressions such as “at least one of,” when preceding a list of elements, modify the entire list of elements and do not modify the individual elements of the list. Also, as used in the present specification, the term “and/or” includes any one of listed items and all of at least one combination of the items.

Terms used in the present specification are used for explaining a specific exemplary embodiment, not for limiting. Thus, the expression of singularity in the present specification includes the expression of plurality unless clearly specified otherwise in context. Also, terms such as “comprise” and/or “comprising” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

In the present specification, terms such as “first” and “second” are used herein merely to describe a variety of members, parts, areas, layers, and/or portions, but the constituent elements are not limited by the terms. It is obvious that the members, parts, areas, layers, and/or portions are not limited by the terms. The terms are used only for the purpose of distinguishing one constituent element from another constituent element. Thus, without departing from the right scope of the embodiments, a first member, part, area, layer, or portion may refer to a second member, part, area, layer, or portion.

Hereinafter, the exemplary embodiments are described in detail with reference to the accompanying drawings. In the drawings, the illustrated shapes may be modified according to, for example, manufacturing technology and/or tolerance. Thus, the exemplary embodiment may not be construed to be limited to a particular shape of a part described in the present specification and may include a change in the shape generated during manufacturing, for example.

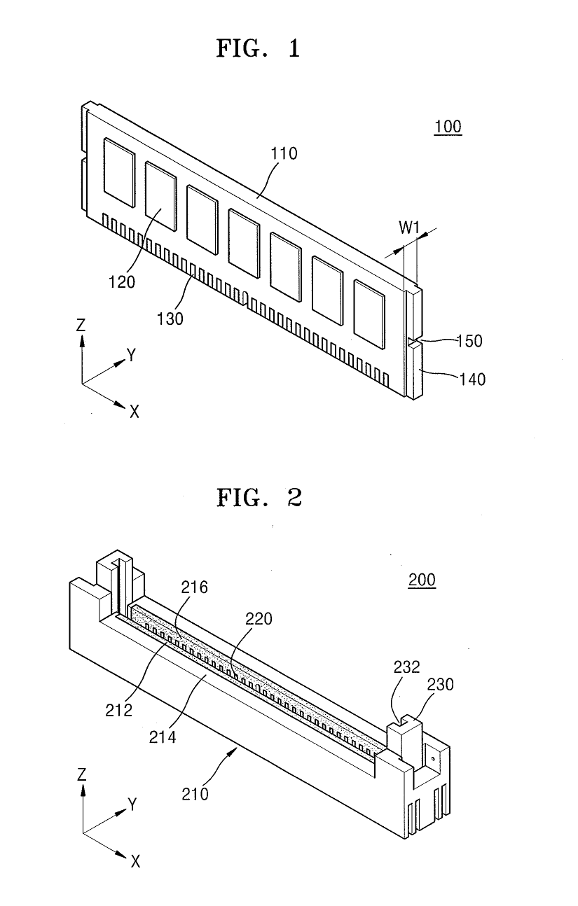

FIG. 1 illustrates a perspective view of a semiconductor module 100 according to an exemplary embodiment.

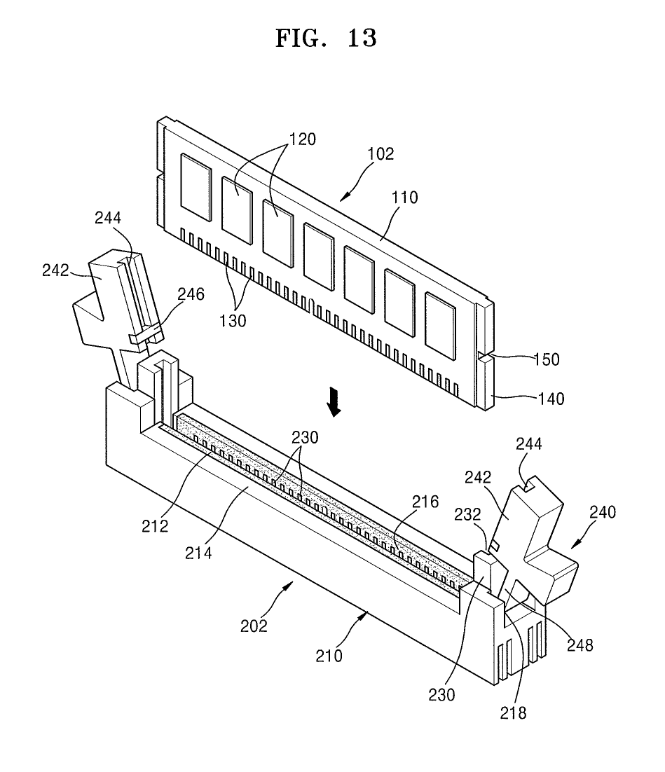

Referring to FIG. 1, the semiconductor module 100 may include a printed circuit board (PCB) 110 having a, e.g., rectangular plate, shape and a plurality of semiconductor devices 120 mounted on the PCB 110. A plurality of external connection terminals 130 may be arranged on opposite surfaces of a lower end portion of the PCB 110 in a X direction, i.e., in a lengthwise direction of the PCB 110. A socket coupling portion 140 that couples to a semiconductor module socket 200 that will be described later (refer to FIG. 2) and a hook insertion groove 150, in which a hook 246 of FIG. 13 that will be described later is inserted, are formed at opposite end portions of the PCB 110 in the X direction.

The semiconductor module 100 may include a memory module. In the exemplary embodiment, the semiconductor module 100 may be at least one of, e.g., a dual in-line memory module (DIMM), a small outline dual in-line memory module (SO-DIMM), an unbuffered DIMM, a fully buffered-DIMM (FB-DIMM), etc.

The PCB 110 may be a substrate on which the semiconductor devices 120 are mounted, and may be, e.g., a PCB card, a plastic substrate, or a semiconductor substrate having other structures. The PCB 110 may have a structure in which a plurality of metal layers and a plurality of insulating layers are alternately stacked. The PCB 110 has a width W1 along the Y direction.

The semiconductor devices 120 mounted on the PCB 110 may be memory devices, e.g., used in personal computers (PCs) or mobile devices. In an exemplary embodiment, the semiconductor devices 120 may include at least one of, e.g., dynamic random access memory (DRAM), static random access memory (SRAM), phase random access memory (PRAM), resistive random access memory (RRAM), electrically erased programmable read only memory (EEPROM), and flash memory.

The external connection terminals 130 may be, e.g., linearly, arranged on a lower end portion of the PCB 110 in the X direction that is the lengthwise direction of the PCB 110. The external connection terminals 130 are mainly used as signal terminals. The signal terminals may include, e.g., an address terminal for inputting an address signal, a command terminal for inputting a command signal, a clock terminal for inputting a clock signal, and a data terminal for inputting or outputting data. In the present exemplary embodiment, the external connection terminals 130 may be terminals including pads, pins, and tabs.

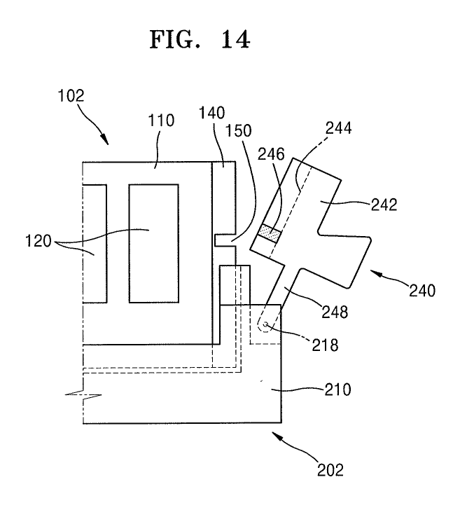

The hook insertion groove 150 is formed in each of the opposite end portions of the PCB 110 in the X direction. For example, as illustrated in FIG. 1, one hook insertion groove 150 may be at each lateral edge of the PCB 110, such that two hook insertion grooves 150 at opposite edges of the PCB 110 may be spaced apart from each other along the X direction. The hook 246 of a latch member 240 (FIGS. 13-14) is inserted into the hook insertion groove 150, thereby fixing the semiconductor module 100 on the semiconductor module socket 200, as will be described later.

FIG. 2 illustrates a perspective view of the semiconductor module socket 200 according to an exemplary embodiment.

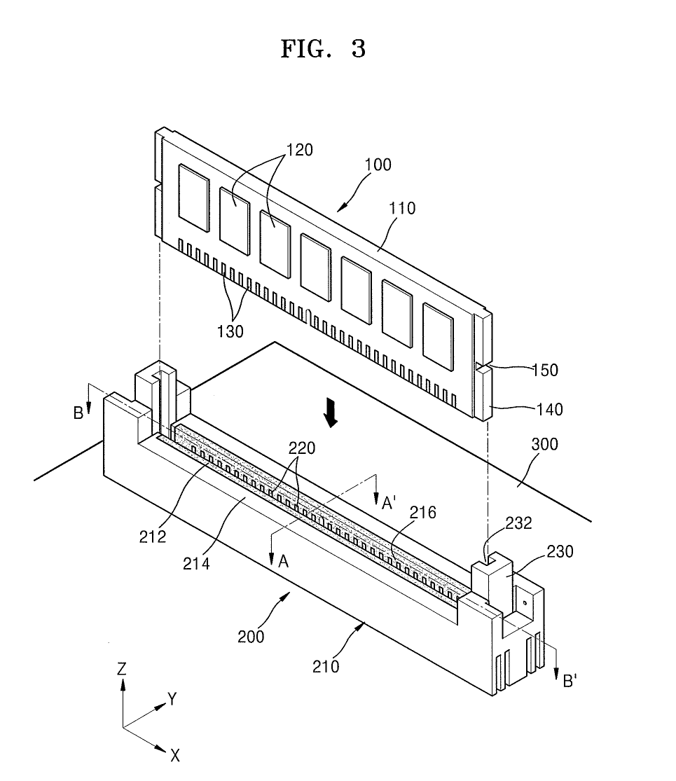

Referring to FIG. 2, the semiconductor module socket 200 is a structure for mounting the semiconductor module 100 of FIG. 1 on a mainboard 300 (FIG. 3). The semiconductor module 100 is coupled to a socket frame 210 and supported thereby. Accordingly, the semiconductor module socket 200 has a structure that electrically connects the semiconductor module 100 and the mainboard 300, and a structure that supports the semiconductor module 100.

In detail, the semiconductor module socket 200 may include the socket frame 210, to which the lower end portion of the PCB 110 of the semiconductor module 100 is coupled, a plurality of socket pins 220 that couple to the external connection terminals 130 of the semiconductor module 100 through contact therewith, and a module coupling portion 230 for fixing the PCB 110.

The socket frame 210 may have a linear shape, e.g., a long rectangle rod shape, in the X direction, i.e., in a same direction as the lengthwise direction of the PCB 110, and may include an internal body 212 and an external body 214. The internal body 212 is formed at each of the opposite sides of the socket frame 210 to face each other in a direction Y that is perpendicular to the lengthwise direction of the socket frame 210 and, as described below, and may be formed of an insulating material for electrical insulation of the socket pins 220 that are formed of a conductive material. In other words, as illustrated in FIG. 2, two portions of the internal body 212 may be on facing inner surfaces of the socket frame 210, and may be spaced apart from each other along the Y direction to define a space therebetween. That is, a slot 216 is formed between the two portions of the internal body 212.

The slot 216 is formed at a center portion of the opposite surfaces of the internal body 212 in the X direction. The lower end portion of the PCB 110 of the semiconductor module 100 is inserted in the slot 216. The socket pins 220 are arranged at opposite surfaces of the slot 216 in the X direction X, i.e., along the lengthwise direction of the socket frame 210, and are physically and/or electrically contacting the external connection terminals 130 provided in the lower end portion of the PCB 110, respectively. The socket pins 220 are coupled to the internal body 212 and supported thereby. When the semiconductor module socket 200 is installed on the mainboard 300, the socket pins 220 are electrically connected to a circuit provided on the mainboard 300. Levels of the top portions of the socket pins 220 arranged, i.e., spaced apart from each other, in the X direction are formed to be different from one another, as will be described in more detail below with reference to FIGS. 3 to 9.

The external body 214 surrounds the internal body 212 and contacts external surfaces thereof. The module coupling portion 230 is coupled to opposite end portions of the socket frame 210 in the X direction that is the lengthwise direction of the external body 214. The opposite end portions of the semiconductor module 100 are coupled to the module coupling portion 230. That is, the module coupling portion 230 includes a lower groove 232, into which a lower portion of each of the opposite end portions of the PCB 110 is inserted. In other words, the socket coupling portions 140 of the PCB 110 are inserted into, e.g., slide and fit into, corresponding lower grooves 232 of the module coupling portion 230. As such, the socket coupling portion 140 in the lower groove 232 provides firm support to the semiconductor module 100 within the semiconductor module socket 200.

FIG. 3 illustrates a perspective view for describing a process of coupling the semiconductor module 100 of FIG. 1 to the semiconductor module socket 200 of FIG. 2.

Referring to FIG. 3, the semiconductor module socket 200 is supported on the mainboard 300, whereas the semiconductor module 100 is coupled to the semiconductor module socket 200 and supported thereby. In detail, the lower end portion of the PCB 110 of the semiconductor module 100 is inserted in the slot 216 formed in the socket frame 210 of the semiconductor module socket 200, and the lower portion of each of the opposite end portions of the PCB 110 in the X direction is inserted in the lower groove 232 formed in the module coupling portion 230. Accordingly, the external connection terminals 130 arranged in the lower end portion of the PCB 110 physically and/or electrically contact the socket pins 220 arranged at the opposite sides of the slot 216, respectively.

When the semiconductor module 100 is inserted in the semiconductor module socket 200, as described above, the lower end portion of the PCB 110 is coupled to the socket frame 210. However, when socket pins of a semiconductor module socket have identical shapes and sizes, and are at a same height level, a force applied to a semiconductor module inserted into the semiconductor module socket, i.e., an insertion force, may generate scratches, damages, floats, or short-circuits in the external connection terminals of the semiconductor module. This is because a physical force is applied to insert the semiconductor module into the semiconductor module socket, and the force may not be uniformly and accurately applied in the left and right directions.

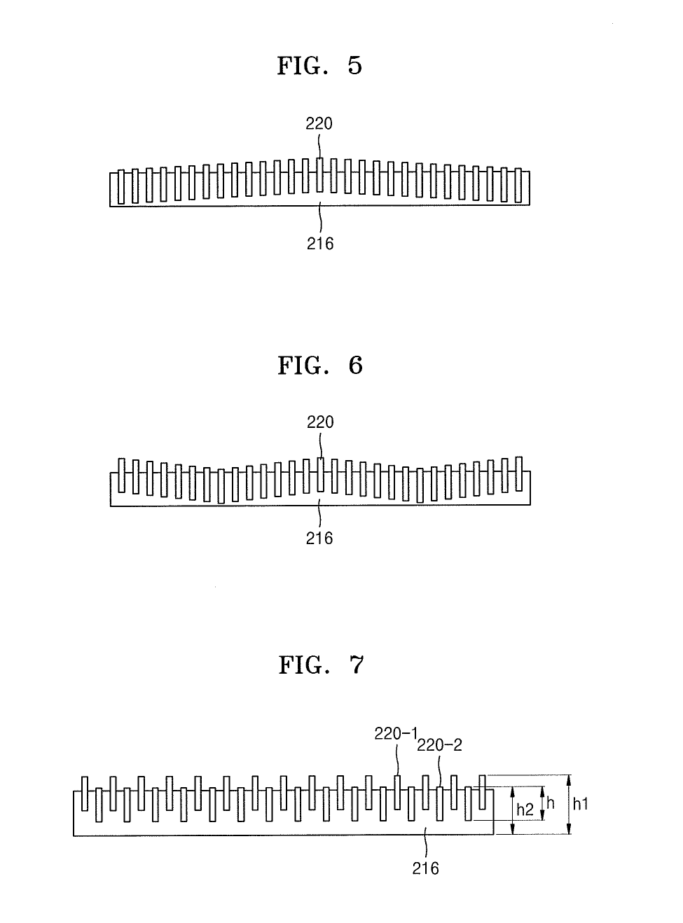

Therefore, according to exemplary embodiments, the socket pins 220 in the semiconductor module socket 200 have different height levels. Also, a step is formed at each of the top portions of the socket pins 220, and thus, when the PCB 110 of the semiconductor module 100 is inserted in the semiconductor module socket 200, the external connection terminals 130 and the socket pins 220 do not contact each other at the same time, so a physical contact frictional force is distributed. As a result, the scratches, damages, short-circuits of the external connection terminals 130 as described above may be prevented and thus the reliability of the semiconductor module 100 may be improved. Also, a step of the external connection terminals 130 formed in the lower end portion of the PCB 110 of the semiconductor module 100 is not adapted, thus the specifications of the Joint Electron Device Engineering Council (JEDEC) may be met. An exemplary embodiment of an array structure of the socket pins 220 is described below in detail with reference to FIGS. 5 to 9.

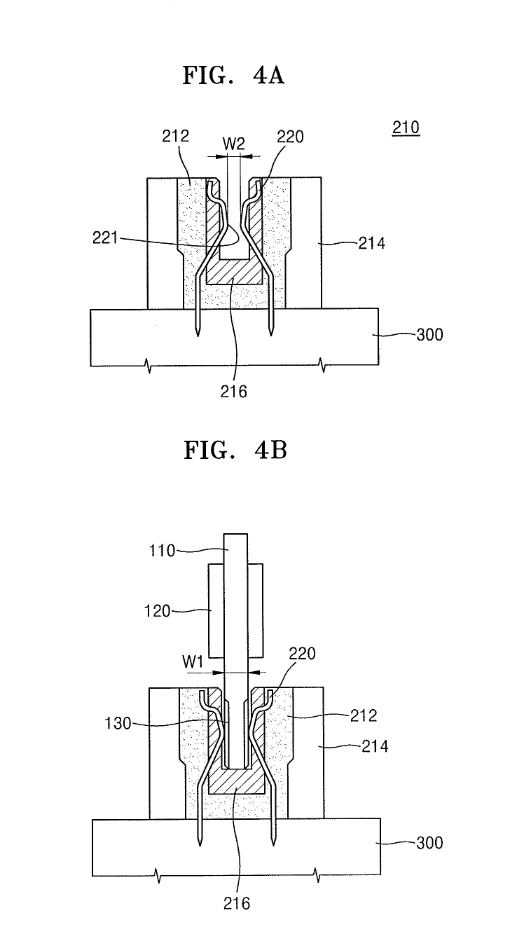

FIGS. 4A and 4B illustrate cross-sectional views of the semiconductor module socket 200 along line A-A′ of FIG. 3 without and with the PCB 100, respectively.

Referring to FIG. 4A, the socket frame 210 of the semiconductor module socket 200 that is fixedly supported on the mainboard 300 may include the internal body 212 and the external body 214. The socket pins 220 are formed in the slot 216 (formed at the center portion between facing portions of the internal body 212) and extend toward the mainboard 300. The socket pins 220 are formed of a conductive material and are physically and/or electrically connected to the mainboard 300. The socket pins 220 are provided in a plurality of pairs facing each other in a direction that is perpendicular to the lengthwise direction of the socket frame 210, i.e., facing each other in the Y direction of FIG. 3. A portion of the slot 216 that is exposed to the outside has a second width W2, i.e., facing protrusions 221 of two facing socket pins 220 on opposite surfaces of the slot 216 are spaced apart from each other by the second width W2 (at a point of a shortest distance therebetween before the PCB 110 is inserted).

Referring to FIG. 4B, the PCB 110 of the semiconductor module 100 is coupled to the socket frame 210. In detail, the lower end portion of the PCB 110 is inserted and installed in the slot 216. The external connection terminals 130 formed in the lower end portion of the PCB 110 make physical and/or electrical contact with the socket pins 220, respectively. The PCB 110 has the first width W1 in a direction perpendicular to the lengthwise direction thereof (direction Y of FIG. 3), and the first width W1 may be larger than the second width W2. Accordingly, as the PCB 110 is inserted in the socket frame 210, the socket pins 220 may be pressed and pushed back and away from each other in opposite directions along the Y direction. In order to push the socket pins 220 back in opposite directions, a constant force is applied to the socket pins 220, i.e., the insertion force. Due to the insertion force, as described above, scratches, damages, and short-circuits of the external connection terminals 130 could be generated if all the socket pins 220 were to have same size, shape, and height level.

FIGS. 5 to 9 illustrate cross-sectional views of the socket pins 220 arranged in the slot 216 of the semiconductor module socket 200 along line B-B′ of FIG. 3, according to exemplary embodiments. For convenience of explanation, FIGS. 5 to 9 illustrate only a portion where the socket pins 220 are arranged. The levels of the top portions of the socket pins 220 illustrated in FIGS. 5 to 9 are formed to be different from one another and arranged parallel to one another in the lengthwise direction of the slot 216. It is further noted that the levels of the top portions of the socket pins 220 illustrated in FIGS. 5 to 9 refer to exposed portions of the socket pins 220 inside the slot 216, i.e., top portions of protrusions 221, rather than uppermost portions of the socket pins embedded in the socket frame 210.

Referring to FIG. 5, among the socket pins 220, the levels of the top portions of the socket pins 220 formed at the center portion of the slot 216 are higher than the levels of the top portions of the socket pins 220 formed at the opposite end portions of the slot 216. For example, as illustrated in FIG. 5, tops of the socket pins 220 in the center of the slot 216 are higher, i.e., extend farther from a bottom of the slot 216, than tops of the socket pins 220 at edges of the slot 216, so the height of the tops of the socket pins 220 in the center of the slot 216 may, e.g., gradually and symmetrically, decrease towards the opposite edges of the slot 216.

Also, the distances between the top portions and the bottom portions of the socket pins 220 formed in the slot 216 are identical to one another, i.e., lengths of the socket pins 220 along the Z direction are equal to each other. Accordingly, when the PCB 110 of the semiconductor module 100 (FIGS. 1 and 3) is inserted in the slot 216, the external connection terminals 130 of the semiconductor module 100 first frictionally contact the socket pins 220 formed at the center portion of the slot 216 and then contact the opposite end portions of the slot 216, thereby distributing the insertion force.

Although FIG. 5 illustrates that, among the socket pins 220, the levels of the top portions of the socket pins 220 formed at the center portion of the slot 216 are higher than the levels of the top portions of the socket pins 220 formed at the opposite end portions of the slot 216, embodiments are not limited thereto. For example, the levels of the top portions of the socket pins 220 formed at the opposite end portions of the slot 216 may be formed to be higher than the levels of the top portions of the socket pins 220 formed at the center portion of the slot 216. In the latter case, when the PCB 110 of the semiconductor module 100 is inserted in the slot 216, the external connection terminals 130 of the semiconductor module 100 first frictionally contact the socket pins 220 formed at the opposite end portions of the slot 216 and then the socket pins 220 formed at the center portion of the slot 216, thereby distributing the insertion force.

Referring to FIG. 6, the levels of the top portions of the socket pins 220 that are arranged in parallel in the lengthwise direction of the slot 216 are formed to be different from one another in a wavy pattern shape. For example, as illustrated in FIG. 6, the height of the tops of the socket pins 220 decreases from the center of the slot 216 toward opposite edges of the slot 216 along the X direction, and then increases again to have the highest height at the center and edges of the slot 216. As in the case of FIG. 5, when the PCB 110 of the semiconductor module 100 (refer to FIGS. 1 and 3) is inserted in the slot 216, the external connection terminals 130 of the PCB 110 and the socket pins 220 frictionally contact with each other in the height order of the socket pins 120, i.e., from the socket pins 220 having top portions that have high levels. Accordingly, the insertion force is distributed and thus damage to the external connection terminals 130 may be reduced.

Referring to FIG. 7, the socket pins 220 are alternately arranged at two different heights in the slot 216, so top portions of the socket pins 220 alternate at two different levels. In detail, the top portions of the socket pins 220 are formed to have two levels of a first height h1 and a second height h2. A socket pin 220-1 having a level of the first height h1 and a socket pin 220-2 having a level of the second height h2 are alternately formed in the lengthwise direction of the slot 216. As described above, when the levels of the top portions of the socket pins 220 are different and alternately formed, and the PCB 110 of the semiconductor module 100 (refer to FIGS. 1 and 3) is inserted in the slot 216, the external connection terminals 130 of the PCB 110 and the socket pins 220 frictionally contact with each other such that the socket pin 220-1 with the first height h1 is first contacted and then the socket pin 220-2 with the second height h2 is contacted. Accordingly, the frictional force due to the contact between the external connection terminals 130 and the socket pins 220 may be distributed, and the insertion force of the semiconductor module 100 may be distributed, thereby reducing the damage to the external connection terminals 130.

However, the socket pin 220-1 having the level of the first height h1 and the socket pin 220-2 having the level of the second height h2 are formed to have an identical distance between the top portion and the bottom portion of each of the socket pins 220, that is, a height h of each of the socket pins 220. That is, a length of the socket pins 220-1 and 220-2 along the Z direction is identical, i.e., height h, and the first and second heights h1 and h2 refer to the distances from the bottom of the slot 216 to respective tops of the socket pins 220-1 and 220-2, as illustrated in FIG. 7.

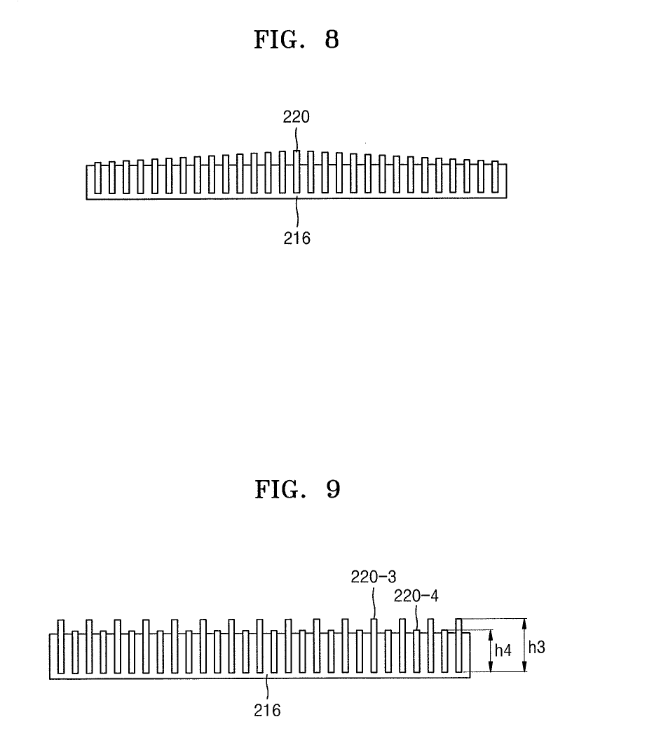

Referring to FIG. 8, the top portions of the socket pins 220 are formed in the slot 216 to have different levels and, as in the case of FIG. 5, the levels of the top portions of the socket pins 220 formed at the center portion of the slot 216 are higher than the levels of the top portions of the socket pins 220 formed at the opposite end portions of the slot 216. The exemplary embodiment of FIG. 8 is different from that of FIG. 5 in that all bottom portions of the socket pins 220 are formed at the same level. Since all bottom portions of the socket pins 220 are formed at the same level, the distances, i.e., the heights, between the top portions and the bottom portions of the socket pins 220 are formed to be different from one another. The effect obtained by the different levels of the top portions of the socket pins 220 is the same as that described with reference to FIG. 5, a description of which is omitted here. Also, as described above with reference to FIG. 5, the exemplary embodiment of FIG. 8 is not limited thereto and the levels of the top portions of the socket pins 220 formed at the opposite end portions of the slot 216 may be formed to be higher than the levels of the top portions of the socket pins 220 formed at the center portion of the slot 216.

Referring to FIG. 9, the alternate arrangement of the socket pins 220 formed in the slot 216 is the same as the arrangement according to the exemplary embodiment of FIG. 7. In other words, two types of socket pins 220-3 and 220-4 having top portions that have two levels of a third height h3 and a fourth height h4 among the socket pins 220 are alternately formed in the lengthwise direction of the slot 216. However, the exemplary embodiment of FIG. 9 is different from the exemplary embodiment of FIG. 7 in that all levels of the bottom portions of the socket pins 220 are identical to one another. Accordingly, unlike the exemplary embodiment of FIG. 7, the distances, i.e., the heights, between the top portions and the bottom portions of the socket pins 220-3 having the third height h3 and the socket pins 220-4 having the fourth height h4 are different from each other. The effect obtained by the different levels of the top portions of the socket pins 220 is the same as that described with reference to FIG. 7, a description of which is omitted here.

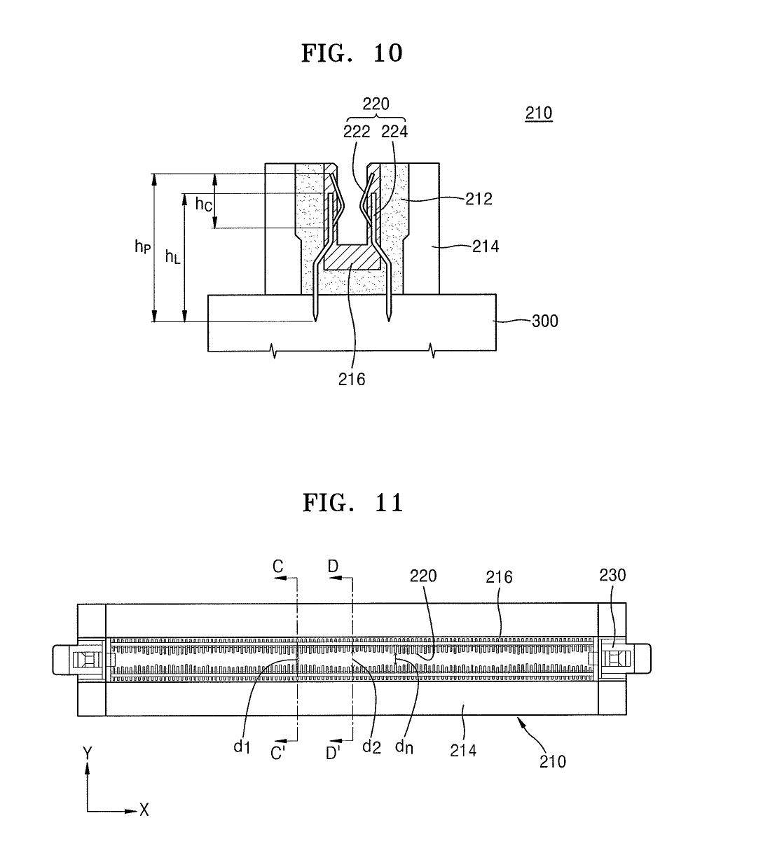

FIG. 10 illustrates another cross-sectional view of the semiconductor module socket 200 along line A-A′ of FIG. 3.

Referring to FIG. 10, the socket frame 210 of the semiconductor module socket 200 that is fixedly supported on the main board 300 may include the internal body 212 and the external body 214. The socket pins 220 are formed in the internal body 212 and the slot 216 that is formed at the center portion of the internal body 212 and extend to the mainboard 300. The socket pins 220 may include a socket pin contact portion 222 and a socket pin connection portion 224. The socket pin contact portion 222 is physically and/or electrically connected directly to the external connection terminals 130 that are formed on the PCB 110 of the semiconductor module 100 (refer to FIGS. 1 and 3). The socket pin connection portion 224 extends in the slot layer 216, the internal body 212, and the mainboard 300, and is connected to a lower end portion of the socket pin contact portion 222.

A height h_{P} of each of the socket pins 220 may be the same as or less than a sum of a height h_{C} of the socket pin contact portion 222 and a height h_{L} of the socket pin connection portion 224. The levels of the top portions of the socket pins 220 are formed to be different from one another, i.e., as any of levels discussed previously with reference to FIGS. 5 to 9. This is because each of the height h_{P} of each of the socket pins 220, the height h_{C} of the socket pin contact portion 222, and the height h_{L} of the socket pin connection portion 224 may be different from one another. As described above with reference to FIGS. 5 to 9, since the levels of the top portions of the socket pins 220 are different from one another, the insertion force generated when the PCB 110 of the semiconductor module 100 is inserted in the slot 216 may be distributed.

FIG. 11 illustrates a plan view of a semiconductor module socket 202 according to an exemplary embodiment.

Referring to FIG. 11, the socket frame 210 may include the internal body 212 and the external body 214. The internal body 212 includes two portions facing each other in the Y direction that is perpendicular to the lengthwise direction of the socket frame 210. The socket pins 220 are formed at the center portion between the two portions of the internal body 212. Like the internal body 212, the socket pins 220 form a plurality of pairs spaced apart from each other in the Y, and are arranged in parallel along the direction X. A distance between one pair of the socket pins 220 along the Y direction is different from a distance between another pair of the socket pins 220 along the Y direction, while the two pairs being spaced apart from each other the X direction.

In detail, the socket pins 220 are formed such that distances between the pairs of the socket pins 220 facing each other in the Y direction in FIG. 11 are different values, e.g., d1, d2, . . . , dn, where “n” is 3 or more. The distances between the pairs of the socket pins 220 are set to be different from one another so that the external connection terminals 130 of the PCB 110 and the socket pins 220 contact at different points when the PCB 110 of the semiconductor module 100 (refer to FIGS. 1 and 3) is inserted in the socket frame 210. Accordingly, the insertion force of the semiconductor module 100 may be distributed.

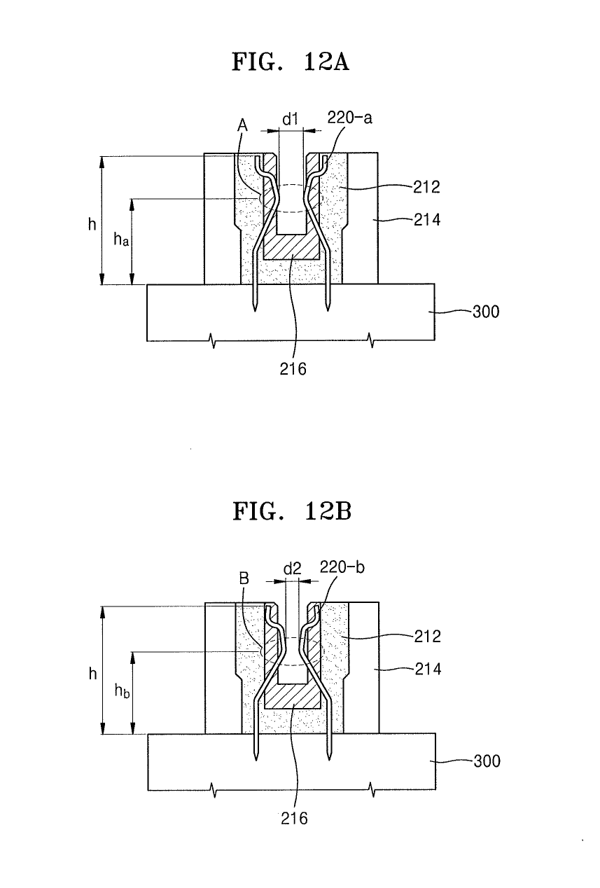

FIGS. 12A and 12B illustrate cross-sectional views of the semiconductor module socket 200 along the lines C-C′ and D-D′ of FIG. 11.

Referring to FIG. 12A, which is a cross-sectional view of the semiconductor module socket 200 along the line C-C′ of FIG. 11, a pair of socket pins 220-a are arranged to face each other and are spaced apart from each other by a first distance d1. A distance between the top portion of each of the socket pins 220-a and an upper surface of the mainboard 300, i.e., a height of the socket pins 220-a, has a value “h”. An area, i.e., a contact point, where the socket pins 220-a and the external connection terminals 130 of the semiconductor module 100 (refer to FIGS. 1 and 3) contact each other is separated from the upper surface of the mainboard 300 by a height “hₐ”.

Referring to FIG. 12B, which is a cross-sectional view of the semiconductor module socket 200, taken along the line D-D′ of FIG. 11, a pair of socket pins 220-b is arranged to face each other and are spaced apart from each other by a second distance d2. A distance between the top portion of each of the socket pins 220-b and the upper surface of the mainboard 300, i.e., a height of the socket pins 220-b, has the same value “h” as that of the socket pins 220-a of FIG. 12A. An area, i.e., a contact point, where the socket pins 220-b and the external connection terminals 130 of the semiconductor module 100 (refer to FIGS. 1 and 3) contact each other is separated from the upper surface of the mainboard 300 by a height “h_{b}”.

The height values “hₐ” and “h_{b}” of the exposed portions of the socket pins 220-a and 220-b may be different from each other. Also, pairs of the socket pins 220-a and 220-b may be separate from each other respectively by the first distance d1 and the second distance d2. As described above, the heights and distance values of the exposed portions of the socket pins 220-a and 220-b may be different from each other. Since contact points of the external connection terminals 130 and the semiconductor module 100 are formed to be different from one another, the insertion force generated when the semiconductor module 100 is inserted in the semiconductor module socket 200 may be distributed.

FIG. 13 illustrates a perspective view of the semiconductor module socket 202 according to an exemplary embodiment.

Referring to FIG. 13, a semiconductor module 102 according to another exemplary embodiment is coupled to the semiconductor module socket 202. Like the semiconductor module 100 of FIG. 1, the semiconductor module 102 may include the PCB 110 having a rectangular plate shape, the semiconductor devices 120 mounted on the PCB 110, the socket coupling portion 140 that couples to the semiconductor module socket 202, and the hook insertion groove 150. In the following description, detailed descriptions of previously described elements are omitted.

The semiconductor module socket 202 according to the present exemplary embodiment, like the semiconductor module socket 200 of FIGS. 2 and 3, may include the socket frame 210 formed of the internal body 212 and the external body 214. Descriptions of the internal body 212, the external body 214, the slot 216, and the socket frame 210 are omitted here. The semiconductor module socket 202 is different from the semiconductor module socket 200 of FIGS. 2 and 3 in that semiconductor module socket 202 includes the latch member 240 for fixing the semiconductor module 102.

The latch member 240 is pivotally coupled to an upper portion of a latch coupling portion 218 formed at opposite end portions of the external body 214 in a lengthwise direction of the external body 214, i.e., the X direction. The latch member 240 may include a latch body 242 that is pivotally coupled to the latch coupling portion 218, and the hook 246 formed on an inner surface of the latch body 242. A pivot shaft 248 protrudes from a lower end portion of the latch body 242. As the pivot shaft 248 is inserted in the latch coupling portion 218 to be coupled thereto, the latch member 240 is pivotally coupled to the latch coupling portion 218 to be capable of rotating. An upper groove 244, in which the upper portion of each of the opposite end portions of the PCB 110 of the semiconductor module 102 in the lengthwise direction of the PCB 110, i.e., the X direction, is inserted, is formed in the latch body 242. When the semiconductor module 102 is coupled to the semiconductor module socket 202, the upper groove 244 is linearly connected to the lower groove 232 in the module coupling portion 230 of the socket frame 210. The latch body 242 may be formed of a metal material, e.g., copper (Cu) or aluminum (Al).

The latch body 242 and the socket coupling portion 140 of the PCB 110 contact each other in, e.g., through, the upper groove 244. The hook 246 is inserted in the hook insertion groove 150 formed in each of the opposite end portions of the PCB 110 in the lengthwise direction of the PCB 110, i.e., the X direction. Accordingly, the semiconductor module 102 is fixedly supported in the semiconductor module socket 202. The hook 246 may be formed of an insulating material to be insulated from the socket coupling portion 140. The hook 246, formed of an insulating material, may be coupled to the latch body 242 as a separate member. Since insertion of the semiconductor module 102 in the semiconductor module socket 202 to be coupled thereto, as well as the physical and/or electrical coupling of the socket pins 220 to the external connection terminals 130 in the lower end portion of the PCB 110 of the semiconductor module 102 are the same as those described previously with reference to FIG. 3, except for the latch member 240, descriptions thereof are omitted here.

FIG. 14 illustrates a partially enlarged cross-sectional view of a process of the latch member 240 of FIG. 13 being coupled to the semiconductor module 102.

Referring to FIG. 14, when the lower end portion of the PCB 110 is inserted in the slot 216 of the semiconductor module socket 202, the latch member 240 rotates toward the semiconductor module socket 202 to extend in a direction perpendicular to a main surface of the socket frame 210, i.e., along the Z direction. At this time, the hook 246 of the latch member 240 is inserted in the hook insertion groove 150, and the upper portion of each of the opposite end portions of the PCB 110 in the lengthwise direction of the PCB 110, i.e., the X direction, is inserted in the upper groove 244 of the latch body 242. Accordingly, the semiconductor module 102 is fixed to the semiconductor module socket 202, and the socket coupling portion 140 of the PCB 110 and the latch body 242 make physical contact with each other.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A semiconductor module socket, comprising:
an internal body including a slot therein, a lower end portion of a semiconductor module being inserted in the slot, and the semiconductor module including a printed circuit board with a semiconductor device thereon;
an external body coupled to an outside of the internal body; and
a plurality of socket pins on opposite surfaces of the slot, the plurality of socket pins facing each other, and top portions of the plurality of socket pins being arranged at different levels.

2. The semiconductor module socket as claimed in claim 1, wherein, among the plurality of socket pins, the levels of the top portions of the plurality of socket pins at a center of the slot are higher than the levels of the top portions of the plurality of socket pins at opposite end portions in a first direction of the slot.

3. The semiconductor module socket as claimed in claim 1, wherein, among the plurality of socket pins, the levels of the top portions of the plurality of socket pins at opposite end portions in a first direction of the slot are higher than the levels of the top portions of the plurality of socket pins at a center of the slot.

4. The semiconductor module socket as claimed in claim 1, wherein the levels of the top portions of the plurality of socket pins have heights of a first level and a second level that are different from each other, and, among the plurality of socket pins, socket pins having top portions at the first level and socket pins having top portions at the second level are alternately arranged in a first direction of the slot.

5. The semiconductor module socket as claimed in claim 1, wherein distances between the top portions and bottom portions of the plurality of socket pins are identical to each other.

6. The semiconductor module socket as claimed in claim 1, wherein levels of contact points between the plurality of socket pins and respective external contact terminals are different from each other.

7. The semiconductor module socket as claimed in claim 1, wherein all bottom portions of the plurality of socket pins are at a same level in the slot.

8. The semiconductor module socket as claimed in claim 7, wherein the plurality of socket pins includes a plurality of socket pin contact portions and a plurality of socket pin connection portions, and heights of the plurality of socket pin connection portions are different from one another.

9. The semiconductor module socket as claimed in claim 1, further comprising:
a lower groove coupled to a lower end portion of the printed circuit board; and
a coupling portion at opposite end portions in a first direction of the external body.

10. A semiconductor module socket assembly structure, comprising:
a semiconductor module including:
a printed circuit board,
at least one semiconductor device on the printed circuit board, and
a plurality of external contact terminal on a lower end portion of opposite surfaces of the printed circuit board; and
a semiconductor module socket electrically connected to the semiconductor module, the semiconductor module socket including:
an internal body including a slot therein, a lower end portion of the printed circuit board being inserted in the slot,
an external body coupled to an outside of the internal body, and
a plurality of socket pins on opposite surfaces of the slot and facing each other, the plurality of socket pins electrically contacting corresponding external contact terminals of the semiconductor module, and top portions of the plurality of socket pins being arranged at different levels.

11. The semiconductor module socket assembly structure as claimed in claim 10, wherein levels of contact points between the plurality of socket pins and the corresponding external contact terminals are different from each other.

12. The semiconductor module socket assembly structure as claimed in claim 10, wherein a distance between a pair of socket pins facing each other in the slot is different from a distance between an adjacent pair of socket pins facing each other in the slot, the pairs of socket pins being adjacent to each other along the first direction.

13. The semiconductor module socket assembly structure as claimed in claim 10, wherein the external contact terminals are tabs for circuit connection.

14. The semiconductor module socket assembly structure as claimed in claim 10, wherein:
the semiconductor module further comprises a hook insertion groove in each of opposite end portions in a first direction of the printed circuit board, and
the semiconductor module socket further comprises a latch member, the latch member being coupled to the hook insertion groove.

15. The semiconductor module socket assembly structure as claimed in claim 14, wherein the latch member includes:
a latch body pivotally coupled to the hook insertion groove; and
an upper groove in the latch body, the upper groove being coupled to an upper end portion of opposite end portions in the first direction of the printed circuit board.

16. A semiconductor module socket for connecting a semiconductor module having at least one semiconductor device on a printed circuit board, the semiconductor module socket comprising:
an internal body including a slot, a lower end portion of the semiconductor module being inserted in the slot;
an external body on outer surfaces of the internal body; and
a plurality of socket pins facing each other in the slot, the lower end portion of the semiconductor module in the slot contacting the plurality of socket pins, and contact points between the semiconductor module and the plurality of socket pins being at different height levels relative to a bottom of the slot.

17. The semiconductor module socket as claimed in claim 16, wherein each of the plurality of socket pins includes a protrusion extending from the internal body into the slot, a distance between two facing protrusions of corresponding socket pins along a first direction being smaller than a width of the slot along the first direction.

18. The semiconductor module socket as claimed in claim 17, wherein the contact points between the semiconductor module and the plurality of socket pins are contact points between the protrusions of the socket pins and corresponding external contact terminals on the semiconductor module.

19. The semiconductor module socket as claimed in claim 16, wherein the contact points between the semiconductor module and the plurality of socket pins have varying height levels along a length direction of the slot.

20. The semiconductor module socket as claimed in claim 16, wherein adjacent contact points between the semiconductor module and the plurality of socket pins are at different height levels relative to the bottom of the slot.
